(19) United States
(12) Patent Application Publication
(10) Pub. No.: US 2019/0174582 A1
(43) Pub. Date: Jun. 6, 2019

(54) GLAZING EQUIPPED WITH AN ELECTRICALLY CONDUCTIVE DEVICE WITH IMPROVED SOLDERING ZONES

(71) Applicant: SAINT-GOBAIN GLASS FRANCE, Courbevoie (FR)

(72) Inventor: Jérôme GUIGNARD, Compiègne (FR)

(21) Appl. No.: 16/320,806

(22) PCT Filed: Jul. 12, 2017
(86) PCT No.: PCT/FR2017/000144

§ 371 Date: Jan. 25, 2019

(30) Foreign Application Priority Data
Jul. 27, 2016 (FR) FR1657234

(51) Int. Cl. H05B 3/84; B32B 17/10

(52) U.S. Cl. CPC H05B 3/84; B32B 17/10036; H05B 2203/016; H05B 2203/013; B32B 17/10174

(57) ABSTRACT

A glazing includes a glass substrate at least one portion of which includes an electrically conductive element including electrically conductive tracks made of a conductive metallic paste forming the electrical network and soldered to a connector by a soldering alloy based on tin, silver and optionally copper level with a soldering zone, the glazing including a single layer of silver paste level with the soldering zone, this single layer ensuring the electrical contact of the conductive element, the conductive metallic paste of the electrical network and the conductive metallic paste level with the soldering zone being silver pastes of different composition.

The present invention relates to a glazing comprising an electrically connecting element, its manufacturing process and its use in the field of automotive glazings.

The invention more particularly relates to a glazing, for motor vehicles, equipped with an electrical function, such as for example a heated or defrosting glazing or even a glazing equipped with an antenna. In glazings comprising heating networks, antennae or other sensors, a series of narrow resistive strips (also called “tracks”) is deposited on the surface of a glass sheet, before the bending and/or tempering operations, so that the baking of the electrically conductive composition may occur during these forming operations. The electrically conductive paste is composed of a pasty suspension of silver metal and a frit (i.e. a low-melting-point glass) in an organic binder. These resistive strips lead on to wider collecting strips that are located near the edges of the glazing. These collecting strips, also called busbars, generally have an identical composition to the composition of the resistive strips and are deposited simultaneously and in the same way.

These strips are connected to a system supplying electrical power via connectors that are soldered to the electrically conductive paste. The soldering of the various elements to one another is a critical point in the manufacturing process of this type of glazing. Specifically, because of differences between the thermal expansion coefficients of the materials used at the soldering points, tensions appear during the manufacture and handling of the glazings, causing weakening of and the appearance of cracks in the glazing, in particular level with the connectors.

The soldering alloys that have been used up to now were particularly ductile because based on lead, thereby ensuring that when the resistance tests specified by manufacturers were performed no cracks appeared that were such as to make the glazing unsuitable for the desired use. A European directive currently forbids the use of these lead-based alloys and much work has been carried out with a view to finding other soldering alloys. A good compromise is obtained with alloys containing tin, silver and optionally copper. These alloys not only possess properties that make them good solders but also have the robustness required to pass the tests currently specified by automotive manufacturers.

The aging tests carried out on connectors and in particular the conditions of temperature cycling tests (TCTs) are however tending to become a lot stricter. The objective of these tests is to determine whether the glazing is able to withstand successive rapid increases and decreases in temperature, without being weakened. The new testing regime specifies that temperature be varied between −40° C. and +105° C., which is a larger variation than used in preceding tests, which were limited to 90° C. The number of cycles has also increased from 10 cycles to at least 60 cycles. Lastly, the phases of the tests in which temperature is increased must be carried out under a voltage of 14 V, this leading to additional local heating, with local temperatures that may reach approximately as high as 120° C. The higher temperatures reached may lead to greater thermal expansion of the connector and also of the soldering alloy, thereby placing more stress on the electrically connecting element in its entirety.

The greater stiffness of alloys based on tin and silver leads to greater transfer of stresses to the substrate, to the point that fissures or cracks may appear after these stricter tests, making the glazings fail.

In order for glazings employing lead-free connectors and soldering alloys to be able to pass the criteria set by these new and increasingly rigorous tests, it has been proposed to use silver pastes having certain specificities, in particular in terms of composition, of deposited thickness and of resistivity, the wires of the heating network and the soldering zones being formed from this silver paste. Level with the soldering zones, in order to ensure that glazings equipped with connectors and alloys can pass the criteria set by these stricter tests, it has proved to be necessary to use two successive layers of silver paste: the first layer of paste is the layer connected to the electrical network and the second layer is a layer that ensures a better mechanical performance after the soldering. These two layers are thus superposed, generally on a black enamel layer allowing the assembly to be masked. The constraints imposed by the choice of silver pastes having certain properties may lead to additional costs related to the particular specificities of the paste.

The aim of the invention is to propose an inexpensive glazing design capable, in the case of use of lead-free soldering alloys, to meet the increasingly rigorous requirements of manufacturers or OEMs in terms of resistance to the strictest of TCT tests.

To this end, the invention relates to a glazing consisting of a glass substrate at least one portion of which comprises an electrically conductive element consisting of electrically conductive tracks made of a conductive metallic paste forming the electrical network and soldered to a connector by a soldering alloy based on tin, silver and optionally copper level with a soldering zone, the glazing comprising a single layer of silver paste level with the soldering zone, this single layer ensuring the electrical contact of the conductive element, the conductive metallic paste of the electrical network and the conductive metallic paste level with the soldering zone being silver pastes of different composition.

Contrary to the electrically connecting systems described in the prior art that comprise two superposed layers of conductive metallic pastes level with the soldering zone, the glazing according to the present invention comprises only a single layer of electrically conductive paste.

It thus becomes possible to dissociate the conductive metallic pastes serving, on the one hand, for the electrical network in its entirety and, on the other hand, for the soldering zone allowing electrical contact with the conductive element to be ensured. The use of a particular conductive metallic paste is then exclusively limited to the soldering zone.

The conductive metallic paste level with the soldering zone is different from the conductive metallic paste used for the rest of the electrical network. The composition of the layer of conductive metallic paste level with the soldering zone is therefore different from the composition of the layer of conductive metallic paste used for the electrical network in its entirety. The conductive metallic paste that forms the single layer level with the soldering zone is therefore chosen so as to be compatible with the connectors used and with lead-free soldering alloys. Preferably, the silver paste level with the soldering zone comprises between 60 and 88% by weight silver before fritting and between 90 and 97% by weight silver after fritting, and therefore after baking at a temperature comprised between 550° C. and 700° C., the rest being glass frit.

The conductive metallic paste level with the soldering zone advantageously possesses certain specificities allowing a good compatibility between the soldering alloy and the connector to be ensured and thus the risk of cracking to be limited. This paste is preferably a silver-based paste possessing a resistivity, measured at a temperature of 25° C., lower than or equal to 3.5 μΩ·cm. These values have proved to be particularly suitable for meeting the requirements of the stricter TCT tests. The composition of the silver paste is therefore advantageously chosen to achieve these resistivity values.

The thickness of the layer of conductive metallic paste level with the soldering zone may be different from the thickness of the layer of conductive metallic paste used for the electrical network in its entirety.

Preferably, the layer of conductive metallic paste level with the soldering zone has a thickness comprised between 5 and 20 μm, said thickness being measured after fritting. Even more preferably, this thickness is comprised between 7 and 15 μm.

The alloy used to solder the electrical connector to the electrically conductive track made of silver is an alloy based on tin, silver and, optionally, copper, and in particular an alloy based on tin, silver and copper. It is a question of an alloy considered to be “lead free”, meeting the standards set by the European directive. Advantageously, the alloy comprises from 90 to 99.5% by weight tin, preferably from 93 to 99% by weight and even more preferably from 95 to 98% by weight tin. It also preferably comprises, in addition to the tin, from 0.5 to 5% by weight silver and from 0 to 5% by weight copper. The alloy may also comprise bismuth, indium, zinc and/or manganese. The soldering alloy is placed on the lower portions of the electrical connector. The thickness of the layer of soldering alloy is preferably smaller than or equal to 600 μm and is even more preferably comprised between 150 and 600 μm.

The electrical connector is made from a metal and the choice of the metal used may in particular be made depending on the soldering alloy. The connector may be made of copper. For lead-free soldering alloys, it is however preferable for it to be made of steel or titanium, these materials possessing lower thermal expansion coefficients than copper. Particularly preferably, the electrical connector is made of stainless steel, i.e. from steel comprising at least 10.5% by weight chromium. This type of connector has the advantage of being compatible with soldering alloys based on tin, silver and copper. Specifically, it is necessary for the various materials to possess thermal expansion coefficients that allow them to be used conjointly without the risk of generating excessively high mechanical stresses, i.e. stresses that will lead to zones of fragility and to the propagation of cracks. In combination with a silver paste possessing a resistivity, measured at a temperature of 25° C., lower than or equal to 3.5 μΩ·cm, stainless steel connectors allow very good performance levels to be achieved under the strictest TCT test conditions.

The electrical connector preferably has a thickness comprised between 0.1 and 2 mm, more preferably between 0.2 and 1 mm and even more preferably between 0.3 and 0.8 mm. It is positioned on the soldering zone, specifically in the location where there is only a single layer of conductive metallic paste.

The connector optionally possesses a wetting layer or coating based on nickel, copper, zinc, tin, silver, or an alloy thereof, on the surface that makes contact with the soldering alloy. Preferably, this coating is based on nickel and/or silver. The thickness of this coating is preferably between 0.1 μm and 0.3 μm for nickel and from 3 to 20 μm for silver.

The electrical connector may possess, on its lower face intended to be placed on the substrate, at least two pads or at least one spacer that make(s) it possible to ensure that the connector and the conductive layer made of silver are correctly connected by way of the soldering alloy and thus to improve the quality of the solder joint.

It goes without saying that the various preferred features described above may be combined together, their combinations allowing the highest performance levels to be achieved under the strictest TCT test conditions. These various combinations have not been listed for the sake of conciseness.

The substrate on which the electrically connecting system is placed is preferably made of glass, and more particularly of plate glass, for example manufactured using a float process in which molten glass is poured onto a bath of molten metal. It may for example be made of a quartz glass, a borosilicate glass, an aluminosilicate glass and/or a soda-lime glass. The substrate may also be polymeric, and may comprise polyethylene, polypropylene, polycarbonate, polymethyl methacrylate, polystyrene, polybutadiene, polynitriles, polyester, polyurethane, polyvinyl chloride, polyacrylates, polyamide, polyethylene terephthalate and/or copolymers or blends thereof. The substrate is preferably transparent. It has a thickness comprised between 0.5 mm and 25 mm, and preferably between 0.5 and 10 mm.

The substrate may be a tempered glass or a non-tempered glass. If a tempered glass is used, the surface layer is reinforced and is therefore stronger, thereby allowing the weakening effects engendered by the presence of the electrically connecting system to be observed more easily.

The invention also relates to a process for manufacturing a glazing such as described above. The process comprises at least the following steps:
depositing electrically conductive metallic tracks in order to form the electrical network on at least one portion of the glass substrate;
depositing a single layer of conductive metallic paste level with the soldering zone between the electrically conductive tracks and the connector, the electrical contacts being formed level with this single layer;
optionally drying the layers of conductive metallic pastes;
fritting the layers of conductive metallic pastes; then
soldering the connector level with the soldering zone.

The deposition of the electrically conductive metallic tracks and of the layer of conductive metallic paste level with the soldering zone is carried out using methods known to those skilled in the art. The depositing steps are preferably carried out by screen printing or by digital printing. They may also be carried out by any other known technique. When the deposition is carried out by screen printing, different screen-printing screens may be used to deposit the electrically conductive tracks forming the electrical network and to deposit the layer of conductive metallic paste level with the soldering zone. The screens are in particular chosen depending on the thickness of the layer that it is desired to deposit on the glazing, and also depending on the composition of the conductive metallic paste.

The step of drying the layers of conductive metallic pastes is optional, depending on the technique used to deposit the layers. If the deposition is carried out by screen printing, it is desirable for a step of drying the layers to take place, preferably at about 150° C., before the fritting step. An intermediate drying step may also be carried out after the step of depositing the electrically conductive metallic tracks forming the electrical network and before the deposition of the layer of conductive metallic paste level with the soldering zone. When the conductive layers are deposited by digital printing, it is not always necessary to dry the conductive layers before the fritting step.

Prior to the depositing steps described above, a layer of black enamel may advantageously be deposited on the glazing, in particular in the locations of the soldering zones, in order to mask them and prevent them from being seen. Here again, the presence of this enamel layer is optional.

The fritting step is a step of baking in air at a temperature comprised between 550° C. and 700° C. for a time varying from 2 to 10 minutes. The silver-based enamel thus fritted forms a solid. Once the fritting step has been carried out, the contact terminals or connectors may then be soldered in order to allow the conductive wires to be supplied with electrical power.

The connector may be soldered to the electrically conductive silver track by stamping, piston soldering, micro-flame soldering, laser soldering, hot-air soldering, induction soldering, resistive soldering and/or ultrasonically. In the present invention, the term “soldering” is used to irrespectively mean brazing, welding or soldering and the term “solder” is used to irrespectively mean braze, weld or solder.

The present invention also relates to the use of a glazing comprising at least one electrically connecting system such as described above, in buildings or vehicles, in particular motor vehicles, rail vehicles or airplanes. The glazings are in particular used as heated windshields, side windows, rear windshields or roofs, or windshields, side windows, rear windshields or roofs equipped with an antenna or any other electrical function placed on or in the glazing.

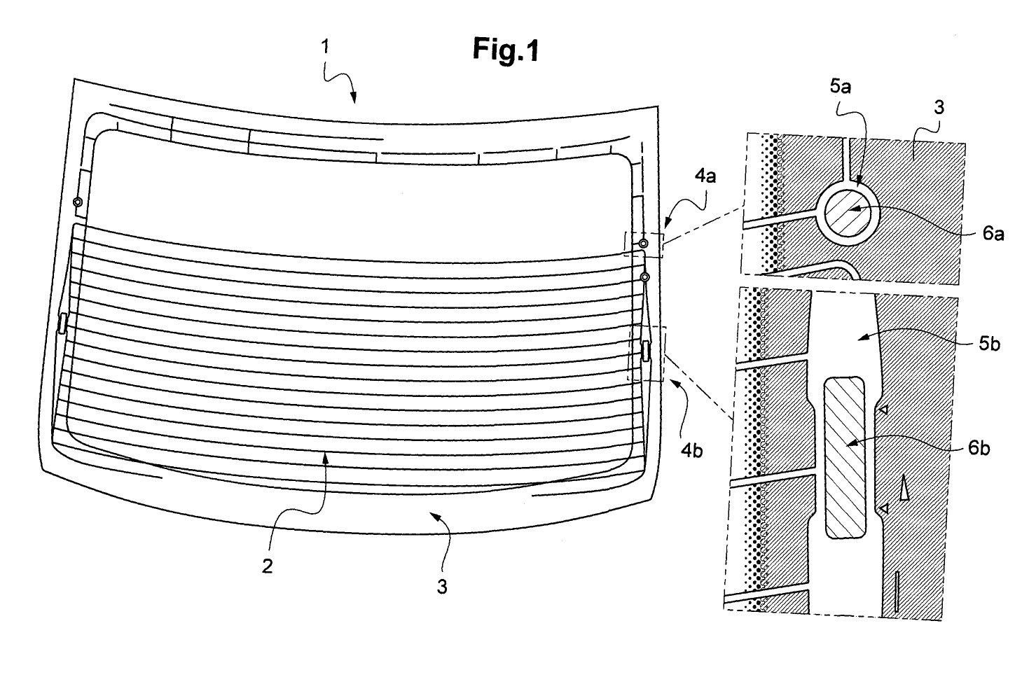

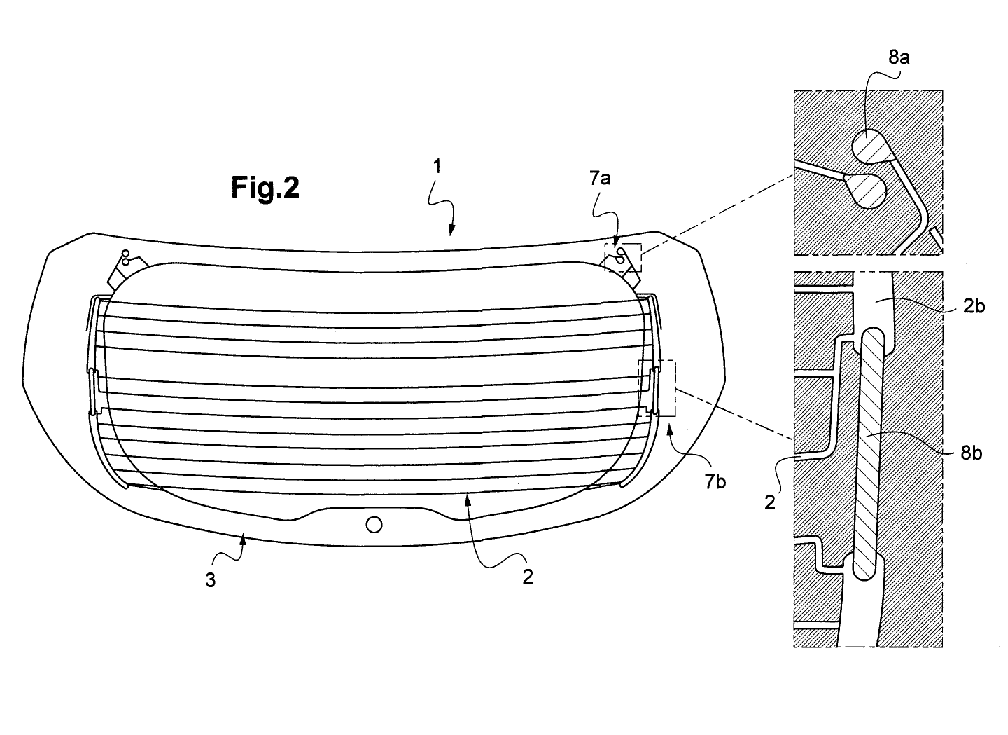

The figures below illustrate the invention. FIG. 1 is a diagram of a type of electrical connection conventionally used in the case of lead-containing solders to meet the requirements of aging tests. FIGS. 2 to 4 are diagrams of types of electrical connections for glazings according to the present invention.

The glazing shown in FIG. 1 is a glazing 1 for example used as a rear windshield equipped with heating conductive wires 2 that are in particular used for defrosting. A black enamel frame 3 is deposited on the periphery of the glazing in order to mask the electrically connecting zones. During the manufacture of such a glazing, the layer deposited first is the layer corresponding to the frame 3, the heating wires 2 being deposited next in this frame. Two soldering and electrically connecting zones 4a and 4b are shown in this figure and have been enlarged. The zone 4a corresponds to a soldering zone on which a “button” shaped connector will be placed, whereas in the zone 4b the connector will be oblong shape. Level with the soldering zone 4a, a layer of conductive metallic paste 5a of the same composition as that of the heating wires 2 is deposited, in the form of a disk of the shame shape as the connector. This layer is then covered with a second silver paste 6a that possesses the characteristics required to allow the soldering alloy and the connector itself to be soldered. Level with the soldering zone 4a, two layers of conductive metallic paste 5a and 6a are therefore superposed, the zone 5a being the busbar zone and the zone 6a being the soldering zone of the connector. For the soldering zone 4b, two successive layers 5b and 6b of conductive metallic pastes are superposed while tailoring the shape of the soldering zone to that of the connector, the zone 5b being the busbar zone and the zone 6b being the soldering zone of the connector.

FIG. 2 shows a glazing according to the invention in which the soldering zones 7a and 7b comprise only a single layer of conductive metallic paste. The single layer 8a, 8b that is level with the soldering zone is the layer that allows the electrical connection to be made with the heating wires 2 via the busbar zone 2b corresponding to a conductive metallic paste of the same composition as that used for the heating wires 2.

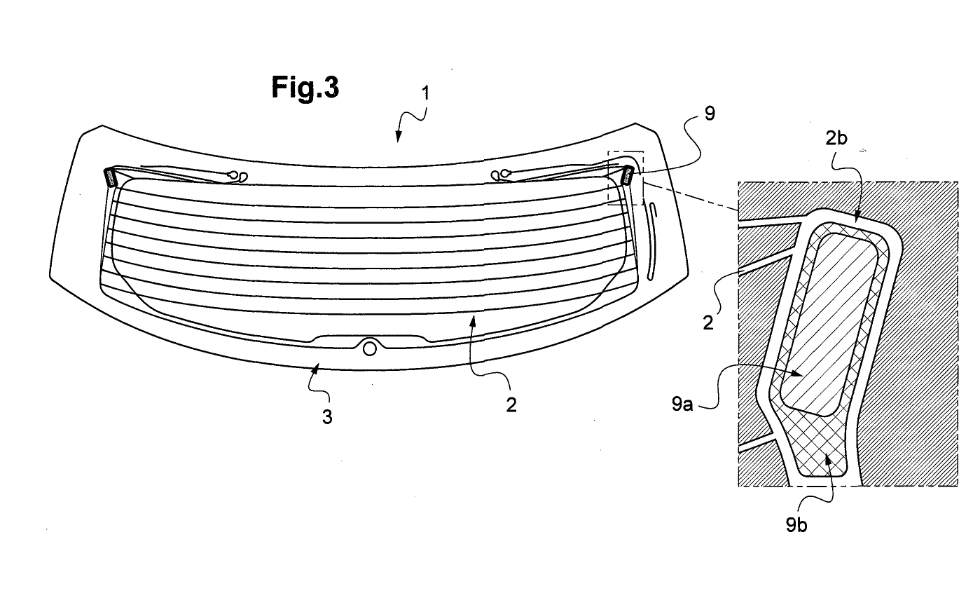

FIG. 3 shows another diagram of a type of connection of a glazing according to the present invention. In this configuration, the soldering zone 9 comprises a portion consisting of a single layer 9a of conductive metallic paste, this portion making direct contact, in order to ensure an electrical connection, with a strip of conductive paste used for the heating wires 2. The connector is positioned on the portion 9a which comprises only a single layer. The transition zone 9b located around the portion 9a is the only zone in which two layers of conductive metallic pastes are superposed. This transition zone does not correspond to the soldering zone on which the connector will be positioned.

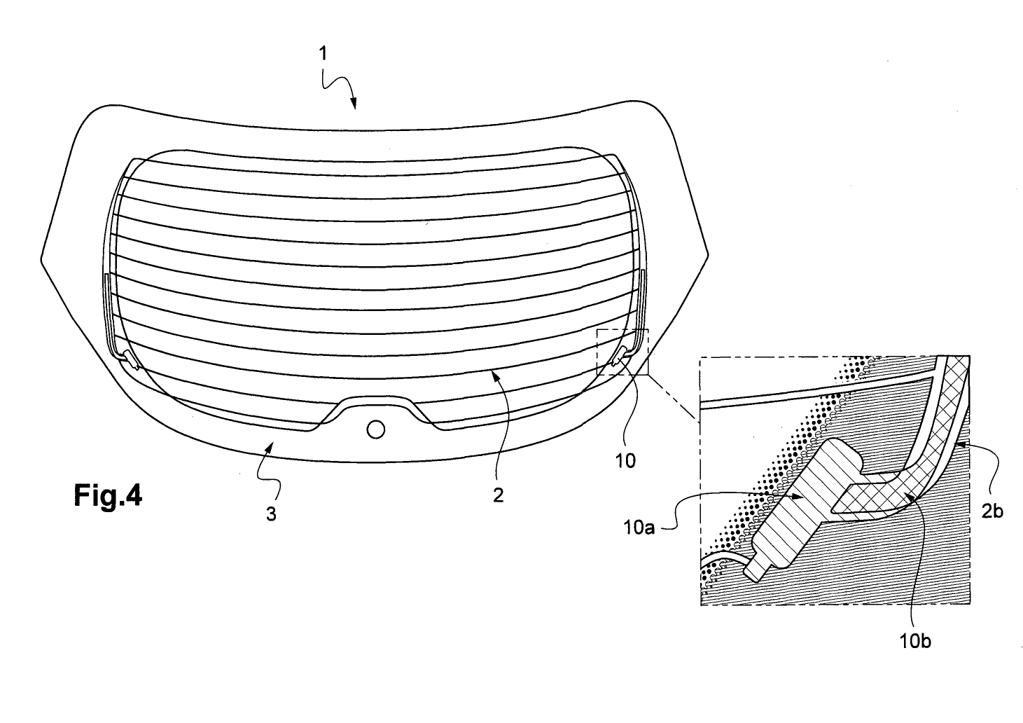

FIG. 4 shows yet another diagram of a type of electrical connection of a glazing according to the invention, in which the soldering zone 10 comprises only a single layer of conductive metallic paste 10a deposited directly on the black enamel layer of the frame 3. In the same way as in FIG. 3, the transition zone 10b is the zone level with which two layers of conductive metallic pastes are superposed, this transition zone not being the soldering zone. The connector is positioned on the zone 10a that comprises only a single layer of conductive metallic paste.

1. A glazing comprising a glass substrate at least one portion of which comprises an electrically conductive element consisting of electrically conductive tracks made of a conductive metallic paste forming an electrical network and soldered to a connector by a soldering alloy based on tin, silver and optionally copper level with a soldering zone, the glazing comprising a single layer of silver paste level with the soldering zone, the single layer ensuring the electrical contact of the electrically conductive element, the conductive metallic paste of the electrical network and the conductive metallic paste level with the soldering zone being silver pastes of different composition.

2. The glazing as claimed in claim 1, wherein the soldering alloy comprises from 90 to 99.5% by weight tin, from 0.5 to 5% by weight silver and from 0 to 5% by weight copper.

3. The glazing as claimed in claim 1, wherein the silver paste level with the soldering zone comprises between 60 and 88% by weight silver before fritting and between 90 and 97% by weight silver after fritting at a temperature comprised between 550° C. and 700° C., the rest being glass frit.

4. The glazing as claimed in claim 1, wherein the silver paste level with the soldering zone possesses a resistivity, measured at a temperature of 25° C., lower than or equal to 3.5μΩ·cm.

5. The glazing as claimed in claim 1, wherein a thickness of the layer of conductive metallic paste forming the electrical network is different from a thickness of the layer of conductive metallic paste level with the soldering zone.

6. The glazing as claimed in claim 1, wherein the layer of conductive metallic paste level with the soldering zone has a thickness comprised between 5 and 20 μm, said thickness being measured after fritting.

7. The glazing as claimed in claim 1, wherein a thickness of the layer of soldering alloy is smaller than or equal to 600 μm.

8. The glazing as claimed in claim 1, wherein the connector is made of stainless steel.

9. A process for manufacturing a glazing as claimed in claim 1, comprising:
depositing electrically conductive metallic tracks in order to form the electrical network on at least one portion of the glass substrate;
depositing a single layer of conductive metallic paste level with the soldering zone between the electrically conductive tracks and the connector, the electrical contacts being formed level with the single layer;
optionally drying the layers of conductive metallic pastes;
and fritting the layers of conductive metallic pastes; then
soldering the connector level with the soldering zone.

10. The process as claimed in claim 9, wherein the two depositing steps are carried out by screen printing or by digital printing.

11. The process as claimed in claim 9, wherein the depositing steps are carried out by screen printing, a drying step taking place before the fritting step.

12. The process as claimed in claim 11, wherein an intermediate drying step is carried out after the deposition of the electrically conductive tracks forming the network and before the deposition of the layer of conductive metallic paste level with the soldering zone.

13. The process as claimed in claim 10, wherein the two depositing steps are carried out with different screen-printing screens.

14. A method comprising arranging a glazing as claimed in claim 1 in a building or a vehicle.

15. The method as claimed in claim 14, wherein the glazing forms a heated windshield, a side window, a rear windshield or a roof, or a windshield, a side window, a rear windshield or a roof equipped with an antenna or any other electrical function placed on or in the glazing.

16. The glazing as claimed in claim 6, wherein the thickness is comprised between 7 and 15 μm, said thickness being measured after fritting.

17. The glazing as claimed in claim 7, wherein the thickness of the layer of soldering alloy is comprised between 150 and 600 μm.

18. The method as claimed in claim 14, wherein the vehicle is a motor vehicle, a rail vehicle or an airplane.
